(19) United States
(12) Patent Application Publication
(10) Pub. No.: US 2013/0339248 A1
(43) Pub. Date: Dec. 19, 2013

(54) UBIQUITOUS PURCHASE PROCUREMENT APPARATUS

(71) Applicant: UBIPAY, L.L.C., Deephaven, MN (US)

(72) Inventors: Thierry Charles Hubert, Arlington, MA (US); Charles Todd Thompson, Deephaven, MN (US)

(21) Appl. No.: 13/920,877

(22) Filed: Jun. 18, 2013

Related U.S. Application Data
(60) Provisional application No. 61/660,982, filed on Jun. 18, 2012.

(51) Int. Cl. G06Q 20/40

(52) U.S. Cl. CPC G06Q 20/40
USPC 705/44

(57) ABSTRACT

A system for facilitating paperless gifting and purchasing may include a server having computer implemented instructions stored thereon for performing the operations of receiving a first image, analyzing the first image for suitability as an identifier for a transaction, generating and issuing a validation code, receiving a transaction packet, and storing the transaction packet in association with the first image on the server. The instructions may separately or additionally include receiving a first image and transaction information relating to an attempted purchase, searching the server by comparing the first image to a plurality of images stored on the server, retrieving a transaction packet associated with a matching image, the matching image being identified amongst the plurality of images when the first image matches one of the plurality of images, comparing the transaction information to information in the transaction packet, and selectively approving the purchase based on the comparison.

### CROSS-REFERENCE TO RELATED APPLICATIONS

The present application is related to and claims priority to U.S. Provisional Patent Application No. 61/660,982 entitled ubiquitous purchase procurement apparatus filed on Jun. 18, 2012, the content of which is hereby incorporated by reference it its entirety.

### FIELD OF THE INVENTION

The invention relates to paperless purchasing, and more particularly, to a system for image-based gift transaction authorization.

### BACKGROUND OF THE INVENTION

The advent of paperless payment transactions generates new forms of payment methods such as gift-cards, debit cards, email-based payments and other forms to paperless purchasing transactions. Financial institutions and merchants are using cards containing an account or reference number needed to perform a secure and identifiable transaction. Consumers are required to possess and present these cards and account identifiers to conclude their purchases. Gift cards for example, can be lost and the money that is associated with them may be lost. Additionally, credit cards are assigned to a unique customer and are legally not transferable to another party for use. Cash is transferable physically or by wire via a banking institution to a known recipient. Today's model puts a burden on the individual to have to comply with institutional means of transfers limited by identifiers or physical transfers of fund to another party.

What is needed, therefore, are techniques for capturing a gift giver's transaction metadata, managing the giver's transactions, authenticating the a merchant's receipt of the metadata, and establishing a financial transaction with the giver's financial institution at the time of purchase for validation and payment.

### SUMMARY OF THE INVENTION

In some embodiments, a system is provided to facilitate the ability for anyone (“Giver”) to choose an image and assign to this image a value, merchant, and intended recipient (“Gift Recipient”). The Gift Recipient can then present the image, or a copy of the image, to the designated merchant for a purchase within the limits of the giver's assigned value and rules.

In some embodiments, techniques and systems are provided for capturing an image and appending and encrypting thereto, the giver's transaction metadata in the form of a transaction packet or a UBIPAY Transaction Packet. The techniques and systems may manage the giver's transactions, authenticate the merchant scan of the image, and establish a financial transaction with the giver's financial institution at the time of purchase for validation and payment.

In one particular embodiment, a system is provided for using any image captured by a giver to be used as an identifier permitting a giver-defined and authorized purchase by a gift recipient at a designated merchant equipped with an image-capable scanning point-of-sale (POS) apparatus.

In another embodiment, a system is provided wherein a giver has control of the nature of the transaction by defining properties such as transaction amount, expiration, preferred vendor and disbursement conditions, for example.

In another embodiment, a system is provided wherein the system is capable to generate a unique code when capturing an image to facilitate the authentication at the time of purchasing. Yet another embodiment includes a system further comprising the capability to prevent fraud. In one behavioral embodiment a new gift-giving model is provided that may increase customer loyalty and the sentiment of gift-giving empowerment that increases consumerisms through extended customer reach and merchant targeting.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a diagram of a process for capturing an image and associating with the image details regarding a transaction, according to some embodiments.

FIG. 2 is a diagram of a process for performing a transaction based on the captured image, according to some embodiments.

### DETAILED DESCRIPTION

In some embodiments, the present disclosure involves utilizing an image selected by a gift giver (“giver”) for purposes of identifying details of a transaction. The gift giver may select an image and capture that image with his/her smartphone or other device. The system described herein may be accessed such that transaction information may be associated with the image such that the image may be gifted to another and the recipient of the gift may use the image to complete a transaction. In some embodiments, the transaction information may include a purchase amount and in other embodiments, the transaction information may include a purchase amount, a particular vendor, an expiration date, and/or a number of transactions that may be used to exhaust the amount stored by the image. Still other transaction parameters may be provided.

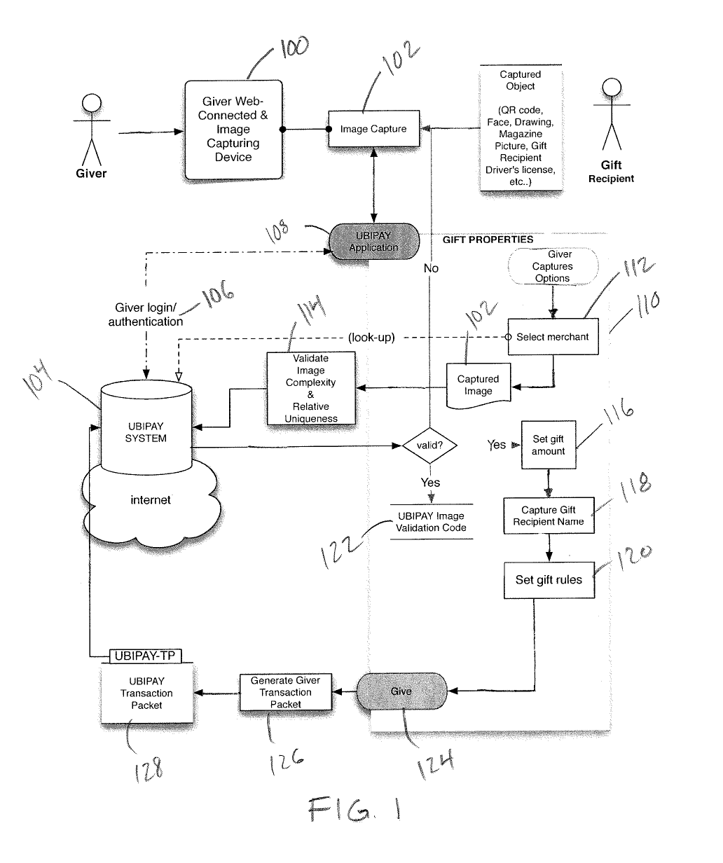

As shown in FIG. 1, a process of capturing an image and assigning properties to the image relating to a transaction is shown. As such, this process may be performed by a gift giver in conjunction with the system and the giver may then provide the resulting captured image to a recipient for later redemption by the recipient.

As shown, the giver may use a web-connected image capture device such as a smart-phone, electronic tablet, or other computing device 100. The giver may capture an image 102 with the device 100. The giver may activate a portion 108 of the system 104 that may be stored on the device 100 or they may open a system web site via a network connection and the system 104 may be accessed via a network such as the Internet. In some cases, the system 104 may call for the giver to login or otherwise authenticate 106 themselves. Where the giver is a first time user, the system may prompt the user to register or otherwise sign up for the service. In still further embodiments, where the system is designed to have a portion 108 of the system 104 stored on the device 100, the login/registration process may include downloading software for utilizing the system 104. Once the user has logged in, the giver may select and upload the captured image 102. In other embodiments, rather than capturing and uploading, the giver may access the system 104 first and capture the image using tools within the system 104. In some embodiments, the login/authentication operation 106 may be adapted to provide secured sessions and may also allow for accessing user-defined preferences.

In some embodiments, the system 104 may prompt or present the give with a user interface 110 that offers a plurality of selection options. In some embodiments, a selection option may be provided for selecting a merchant 112 that is registered with the system 104 and thus may be a business capable of remitting the system gift instructions. The interface may also include a feature for receiving a validation 114 for the captured image 102 to be used by the gift recipient at the selected merchant 112. This feature may trigger a portion 108 of the system to send the captured image 102 to the system validation service 114 to ensure sufficient image complexity and relative uniqueness to other active system images for the intended vendor. If the image is validated, the system 104 may issue a validation code 122. Yet additional selection options may include options for setting the amount of the gift 116, capturing the gift recipient name 118 and setting gift rules 120. For example, one rule may include limiting the transaction to a one-time transaction or allowing multiple transactions until the amount stored is depleted. Still another selection options may include setting a gift expiration. The giver may utilize the interface to validate the image and make one or more selections from the available options and may validate the gift by confirming via a confirmation button, for example, thereby performing a give 124.

The system may generate 126 a giver transaction packet by packaging the information provided by the giver into a secure record containing all the gift properties. The secure record may be in the form of a transaction packet 128. The secure record may be stored on the system 104 poised for redemption by a recipient during a merchant transaction, for example. In other embodiments, the giver may consult the secure record and/or make changes to the properties of the transaction.

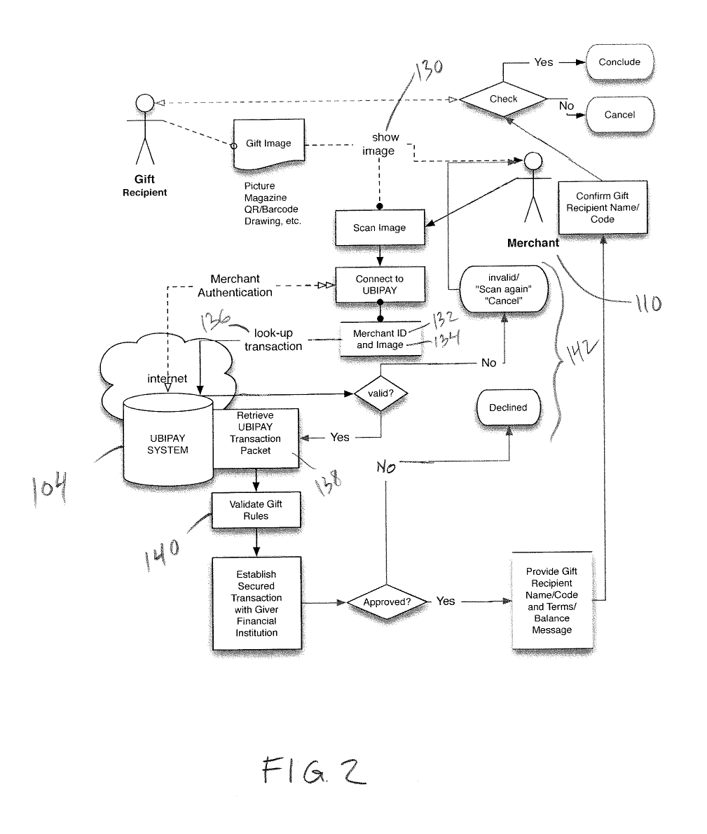

Referring now to FIG. 2, a merchant transaction process is shown. As shown, a merchant 110 may be presented with an image for scanning to retrieve the gift details to obtain authorization to conclude the transaction. For example, a gift recipient may present 130 the image 102 to the merchant 110 for scanning. The merchant 110 may use an image scanning device capable of transmitting the image through a secured network to the system 104 for merchant identification 132, image identification 134, and transaction look-up 136. The system 104 may compose a transaction packet 138 to be sent to the merchant 110 through the secured network. The transaction packet 138 may include either the information that describes and authorizes the gift 140, or rejects the transaction for cause of invalid image, expired transaction or declined payment from the giver's financial institution 142. The system 104 informs the merchant that the transaction is valid but may require the gift recipient to provide additional information, as required by the giver or the system 104, such as a code or name to confirm that the gift recipient is the giver's intended beneficiary.

The system may calls upon known technologies to optimize and code the matching of the giver's images according to color saturation, shape identification and other means of detecting patterns that increase the system's ability to match images. Such technology may, for example, be in current use by search engines such as Google image's search where a selected picture can be used to find similar pictures.

The system may also use this form of image analysis algorithm to identify if the image taken by the giver is not complex enough or if the image is too close to an image already taken for the selected and intended merchant.

However, the system is not limited to complex images and can use the common merchants' denominator image recognition software and hardware currently available. Systems such as QR or barcodes may be used until such time when more sophisticated scanning has been deployed by merchants.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

Although the invention has been described with reference to various embodiments, persons skilled in the art will recognize that changes may be made in form and detail without departing from the spirit and scope of the invention.

What is claimed is:

1. A system for facilitating paperless gifting and purchasing, the system comprising:
a server in communication with a network and accessible by one or more computing devices, the server having computer implemented instructions stored thereon for performing the operations of:
receiving a first image;
analyzing the first image for suitability as an identifier for a transaction;
generating and issuing a validation code;
receiving a transaction packet; and
storing the transaction packet in association with the first image on the server.

2. A system for facilitating paperless purchasing, the system comprising:
a server in communication with a network and accessible by one or more computing devices, the server having computer implemented instructions stored thereon for performing the operations of:
receiving a first image and transaction information relating to an attempted purchase;
searching the server by comparing the first image to a plurality of images stored on the server;
retrieving a transaction packet associated with a matching image, the matching image being identified amongst the plurality of images when the first image matches one of the plurality of images;
comparing the transaction information to information in the transaction packet; and
selectively approving the purchase based on the comparison.

3. A method for facilitating paperless gifting and purchasing, comprising image-based transaction authorization.

4. The method of claim 3, wherein a giver defines the nature of the transaction and assigns the gift to a selected recipient.

5. The method of claim 4, further comprising coding the a giver-selected image to ensure a secure transaction completion.
